(19) United States
(12) Patent Application Publication
(10) Pub. No.: US 2010/0305801 A1
(43) Pub. Date: Dec. 2, 2010

(54) DEVICE FOR THE REGULATION OF DRIVING DYNAMICS

(75) Inventor: Bernhard Giers, Bad Soden (DE)

Correspondence Address: RATNERPRESTIA, P.O. BOX 980, VALLEY FORGE, PA, 19482, US

(73) Assignee: Continental Teves AG & Co.oHG

(21) Appl. No.: 12/744,721

(22) PCT Filed: Nov. 27, 2008
(86) PCT No.: PCT/EP08/66343

§ 371 Date: May 26, 2010

(30) Foreign Application Priority Data
Nov. 27, 2007 (DE) 10 2007 057 043.2

(51) Int. Cl. G06F 19/00

(52) U.S. Cl. 701/29; 701/1

(57) ABSTRACT

A device for the regulation of driving dynamics of a vehicle with an electronic regulator unit and a valve block. The electronic regulator unit is constructed as a support base for attaching the valve block to the vehicle chassis.

### CROSS REFERENCE TO RELATED APPLICATIONS

This application is the U.S. national phase application of PCT International Application No. PCT/EP2008/066343, filed Nov. 27, 2008, which claims to priority to German Patent Application No. 10 2007 057 043.2, filed Nov. 27, 2007, the contents of such applications being incorporated by reference herein.

### FIELD OF THE INVENTION

The invention relates to a device for the regulation of driving dynamics of a vehicle, and to its use in motor vehicles.

### BACKGROUND OF THE INVENTION

DE 197 55 431, which is incorporated by reference, describes a system for the regulation of driving dynamics in which a sensor module for driving dynamics sensors, comprising yaw rate sensors and acceleration sensors, is arranged in an electronic housing which is arranged separately from the hydraulic controller, wherein the driving dynamics electronics which are integrated into the brake electronics are arranged in this housing. The hydraulic controller is connected here to the brake electronics via a system bus.

A further device for the regulation of driving dynamics with an arrangement of the driving dynamics sensors in a separate housing is described in DE 198 47 667 A1, which is incorporated by reference. According to the document, the driving dynamics sensors are located, together with a CPU for the regulation of the brakes, in a housing in the region of the center of the vehicle. In contrast, the power electronics with the valve drivers are integrated into the brake regulator which is connected to the CPU via an interface.

In addition to the devices which are described above and which have “distributed intelligence”, integrated control devices which are space-saving and can be fabricated particularly inexpensively are often used for the regulation of driving dynamics (ESP), and also for ABS, traction control systems etc. A compact design with a monolithic unit composed of an electronic regulator unit and a valve block and which is arranged in the engine compartment of a motor vehicle is characteristic of this type of control device. The regulator unit, which is connected to different types of sensors and activators, such as wheel speed sensors, filling level sensors, electromagnetic hydraulic valves, relays and the like, serves essentially to perform open-loop/closed-loop control of the brakes and to intervene in the engine management. The valve block, which is connected to the regulator unit via a plug-in system, comprises hydraulic valves which are activated magnetically and have the purpose of actuating the brake cylinders and a pump motor which is connected by flanges.

The driving dynamics sensors comprising acceleration sensors and at least one yaw rate sensor are nowadays either in the form of individual components or are combined and housed in a module which is arranged separately from the integrated control device and has dedicated processor intelligence (sensor cluster) accommodated in the region of the center of gravity of the vehicle.

EP 1 313 635 B1, which is incorporated by reference, discloses a device for the regulation of driving dynamics and a method for the orientation of driving dynamics sensors in which the driving dynamics sensors are integrated in the electronic regulator unit and the latter is positioned in or directly on the valve block. This permits inexpensive and compact production of a driving dynamics regulation device.

However, this compact design makes contradictory requirements of the design principle in terms of achieving best possible acoustic insulation of the valve block on the one hand and, on the other hand, provision of the most rigid possible connection to the vehicle chassis of the electronic regulator unit in order to be able to detect the driving dynamics of the vehicle satisfactorily by means of sensors.

### SUMMARY OF THE INVENTION

An object of the invention is proposing a device for the regulation of driving dynamics which permits at least partial vibration insulation and/or sound insulation of the valve block from the vehicle chassis.

The object is achieved according to aspects of the invention by means of the device for the regulation of driving dynamics.

An object of the invention is therefore based, in particular, on the concept of attaching the valve block directly or indirectly to the vehicle chassis by means of the regulator unit.

An inventive device for the regulation of driving dynamics has the advantage that at least partial vibration insulation of the valve block from the vehicle chassis is achieved. This relates, in particular, to a reduction in the sound occurring then, which corresponds to an increase in the comfort for the passengers of a vehicle. Furthermore, the motor vehicle chassis is also at least partially insulated from the acoustically imperceptible but disruptive solid-borne sound.

An object of the invention is based on the idea that the valve block is not mounted directly on the vehicle chassis but is rather connected only indirectly thereto via a support base, wherein the electronic regulator unit serves as part of this support base and/or as the support base.

The attachment of the entire regulator system comprising the electronic regulator and the valve block is preferably carried out by means of a support on the vehicle chassis.

One or more damping elements are preferably arranged between the electronic regulator unit and the valve block. In particular, at least one of these damping elements is embodied as an elastic body with at least one attachment means anchored therein on each side, wherein at least one of the attachment means is connected to the electronic regulator unit, and at least one other attachment means is connected to the valve block.

The electronic regulator unit expediently comprises a housing which has at least a first housing area which is of elastic design or has elastic properties. The valve block is particularly preferably attached to the housing of the electronic regulator unit here. This housing area quite particularly preferably has an essentially meandering structure. This embodiment is relatively robust and inexpensive and ensures at least partial insulation of the valve block from the vehicle body.

The valve block preferably also comprises the pump motor of the hydraulic pump and/or the hydraulic pump is connected to the valve block, as a result of which the hydraulic pump is also at least partially sound-insulated or vibration-insulated from the vehicle chassis, which leads, inter alia, to increased comfort.

It is expedient that the electronic regulator unit is connected in an essentially rigid, direct or indirect fashion to the vehicle chassis by at least one connecting means. This permits relatively good sensory coupling by means of a relatively good vibration coupling or sound coupling of the electronic regulator unit to the vehicle chassis.

A number of driving dynamics sensors is advantageously arranged in the electronic regulator unit, which permits a higher level of integration of the entire regulation system.

It is expedient that the driving dynamics sensors are coupled to the vehicle chassis in a rigid, direct or indirect fashion, wherein at least parts of the electronic regulator unit are vibration-insulated or sound-insulated from the vehicle chassis.

It is preferred that the electronic regulator unit has a rotational speed sensor and/or an acceleration sensor which has, in particular, multiple axes or is suitable for detection in different spatial directions. In this context, this at least one sensor is connected in an essentially rigid fashion, directly or indirectly, to a housing floor of the regulator unit, which housing floor is arranged opposite the vehicle chassis, or to at least one connecting means which connects the regulator unit in an essentially rigid fashion to the vehicle chassis. This permits relatively good vibration coupling and/or sound coupling of the at least one sensor to the vehicle chassis in order, for example, to detect the rotational speed about the vertical axis of the vehicle and/or to detect the solid-borne sound for the triggering of airbags. The one or more sensors are particularly preferably arranged here on a printed circuit board which is essentially rigidly connected to the at least one connecting means for connecting the electronic regulator and chassis. This printed circuit board is, in particular, a flexible printed circuit board or a flexible film circuit board and, for example, is clipped onto, or in the vicinity of, at least one connecting means. The electronic unit quite particularly preferably comprises here a yaw rate sensor and a longitudinal or lateral acceleration sensor.

It is expedient that the electronic connections, in particular cable connections between the electronic regulator, in particular the regulator circuit board, and the valve block/pump motor are of elastic and/or flexible design. Alternatively or additionally preferably, the electrical connections are in particular cable connections between the sensor elements and/or sensors which are coupled or connected to the housing floor of the regulator housing particularly preferably in a rigid fashion or indirectly coupled or connected to the vehicle chassis in a rigid fashion, and at least one regulator circuit board or regulator electronic system is formed in an elastic and/or flexible fashion.

The sensors which are integrated into the electronic regulator unit are, for the coupling to the vehicle chassis, preferably arranged as close as possible to the at least one attachment point of the electronic regulator unit to the vehicle chassis and, in particular, connected directly or indirectly thereto. This connection is particularly preferably as rigid as possible.

The vibration coupling or sound coupling preferably relates to a frequency range between 8 Hz and 20 kHz.

The housing of the regulator unit is preferably also configured for performing the function of a damping element. In order to improve further the vibration insulation or sound insulation of the valve block from the vehicle chassis, in one advantageous embodiment a number of damping elements is arranged between the electronic regulator unit and the valve block. As a result, vibrations which occur and which are transmitted from the valve block to the vehicle chassis are attenuated. The comfort for the vehicle occupants during the operation of the device for the regulation of driving dynamics is therefore increased.

In order to promote further a compact design of the device for the regulation of driving dynamics, in one advantageous embodiment a number of driving dynamics sensors is integrated in the electronic regulator unit. The required direct contact of the driving dynamics sensors is given in an extremely simple way by virtue of the additional function of the electronic regulator unit as a support base on the vehicle chassis.

The advantages achieved with the invention consist, in particular, in the fact that a compact and inexpensive design of the device for the regulation of driving dynamics is made possible through the use of the electronic regulator unit as a support base for the attachment of the valve block to the vehicle chassis. Furthermore, it is ensured, on the one hand, that the driving dynamics sensors in the electronic regulator unit can particularly well detect the driving dynamics of the vehicle through the direct contact with the vehicle chassis, and that, on the other hand, the best possible acoustic insulation of the valve block from the vehicle chassis is achieved at the same time.

The invention also relates to the use of the device according to aspects of the invention for the regulation of driving dynamics in motor vehicles.

### BRIEF DESCRIPTION OF THE DRAWINGS

The invention is best understood from the following detailed description when read in connection with accompanying drawings. Included in the drawings is the follow figures:

FIG. 1 shows a first exemplary embodiment of a device for the regulation of driving dynamics, and

FIG. 2 shows a second exemplary device for the regulation of driving dynamics with sensors which are integrated into the electronic regulator unit on a printed circuit board, wherein the printed circuit board is coupled in an essentially rigid fashion to the chassis.

### DETAILED DESCRIPTION OF THE PREFERRED EMBODIMENTS

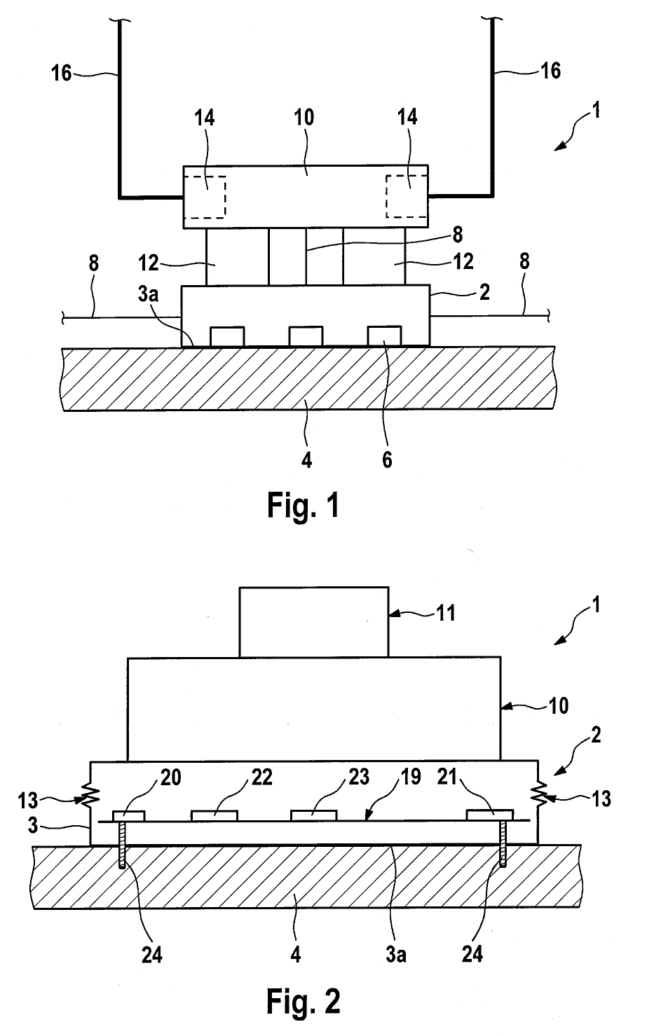

The exemplary driving dynamics regulator 1 according to FIG. 1 comprises an electronic regulator unit 2 which is mounted on the vehicle chassis 4. This electronic regulator unit comprises a number of driving dynamics sensors 6 which are attached to the regulator housing floor 3a and are therefore coupled relatively directly to the vehicle chassis 4 in terms of the transmission of sound or vibrations. Furthermore, signal lines 8, which transmit signals from further driving dynamics sensors, which are situated at different locations on the vehicle, to the electronic regulator unit 2.

A valve block 10 is mounted on the electronic regulator unit via damping elements 12. The valve block 10 has here a number, in the exemplary embodiment two, of valves 14 to which hydraulic lines 16 are connected. The commands which are output by the electronic regulator unit 2 by evaluating the signals received from the driving dynamics sensors are transmitted, for the control of the valves, from the electronic regulator unit 2 to the valve block 10 via a transmission line 18.

The selective design of the electronic regulator unit 2 as a support base of the valve block 10 for mounting on the vehicle chassis 4 permits a compact design of the driving dynamics regulator 1. In this context, the direct contact of the driving dynamics sensors 6 with the vehicle chassis 4 permits both good recording of the driving dynamics data and achieves particularly good acoustic insulation of the valve block 10 from the vehicle chassis 4 as a result of the damping elements 12 between the electronic regulator unit 2 and in the valve block 10. This ensures a secure and reliable method of functioning of the valve block 10 or of the valves 4 for the control of, for example, the airbag or ABS system.

Alternatively, the housing of the regulator unit 2 could also be designed to perform the function of the damping elements 12.

FIG. 2 shows an exemplary driving dynamics regulator 1 of a motor vehicle regulation system, comprising an electronic regulator unit 2 which is connected in an essentially rigid fashion to the vehicle chassis 4 by means of connecting means 24, for example screws. In this context, these connecting means 24 are connected to the regulator unit 2, to the housing floor 3a thereof. The electronic regulator unit 2 comprises a regulator housing 3 to which the valve block 10 is connected. In an alternative exemplary embodiment (not illustrated), this connection is made here by means of at least one additional damping element. The pump motor 11 is arranged on the valve block 10. The regulator housing 3 has an area of the housing wall 13 which is designed in an elastic fashion by means of a meandering wall structure. The printed circuit board 19, which is connected in an essentially rigid fashion to attachment elements 24, is arranged in the electronic regulator unit 2. A yaw rate sensor 20 and a longitudinal and lateral acceleration sensor 21, which is embodied as a dual-axis acceleration sensor, are each arranged on the printed circuit board 19, in the region of a connecting means 24 for performing relatively direct coupling to the vehicle chassis 4. Furthermore, the printed circuit board 19 has an ASIC 23 for processing sensor signals and a power electronic circuit 22 as a central processor unit. The valve block 10 and the pump motor 11 are as a result at least partially vibration-insulated and/or sound-insulated from the vehicle chassis 4, as a result of which in particular the generation of noise due to the operation of pumps and valves in the vehicle is reduced. The integrated sensors 20, 21 are, on the other hand, relatively well coupled to the vehicle chassis and can therefore detect vibrations or sound of the vehicle chassis and the yaw rate of the vehicle relatively precisely and with relatively high sensitivity.

1.-10. (canceled)

11. A device for the regulation of driving dynamics of a vehicle with an electronic regulator unit and a valve block, wherein the electronic regulator unit is constructed as a support base for attaching the valve block to the vehicle chassis.

12. The device for the regulation of driving dynamics as claimed in claim 11, wherein a number of damping elements are arranged between the electronic regulator unit and the valve block.

13. The device for the regulation of driving dynamics as claimed in claim 11, wherein the electronic regulator unit comprises a housing having at least a first housing area which is of elastic configuration or has elastic properties.

14. The device for the regulation of driving dynamics as claimed in claim 13, wherein the valve block is attached to the housing of the electronic regulator unit.

15. The device for the regulation of driving dynamics as claimed in claim 13, wherein the housing area comprises a generally meandering structure.

16. The device for the regulation of driving dynamics as claimed in claim 11, wherein the electronic regulator unit is connected in a substantially rigid, direct or indirect, fashion to the vehicle chassis by at least one connecting means.

17. The device for the regulation of driving dynamics as claimed in claim 11, wherein a number of driving dynamics sensors is arranged in the electronic regulator unit.

18. The device for the regulation of driving dynamics as claimed in claim 11, wherein the electronic regulator unit comprises a rotational speed sensor and/or an acceleration sensor which is/are connected in a substantially rigid fashion, directly or indirectly, to a housing floor of the regulator unit, which housing floor is arranged opposite the vehicle chassis, or to at least one connecting means which connects the regulator unit in a substantially rigid fashion to the vehicle chassis.

19. The device for the regulation of driving dynamics as claimed in claim 18, wherein the acceleration sensor comprises multiple axes.

20. The device for the regulation of driving dynamics as claimed in claim 18, wherein the one or more sensors are arranged on a printed circuit board which is substantially rigidly connected to the at least one connecting means.

21. The use of the device for the regulation of driving dynamics as claimed in claim 11 in motor vehicles.
